(19) United States
(12) Patent Application Publication
(10) Pub. No.: US 2007/0254991 A1
(43) Pub. Date: Nov. 1, 2007

(54) Phosphorus-containing tetrabromobisphenol A

(76) Inventors: Saadat Hussain, Baton Rouge, LA (US); Arthur G. Mack, Prairieville, LA (US)

Correspondence Address: EDGAR SPIELMAN;ALBEMARLE CORPORATION, 451 FLORIDA BLVD., BATON ROUGE, LA, 70801, US

(21) Appl. No.: 11/413,350

(22) Filed: Apr. 28, 2006

(51) Int. Cl. C08K 5/53; C07F 9/40

(52) U.S. Cl. 524/125; 558/127

(57) ABSTRACT

The present invention relates to phosphorous-containing tetrabromobisphenol-A flame retardants, methods for forming the same, and their use as flame retardants in styrenic polymers.

### REFERENCE TO RELATED APPLICATION

This application claims priority to U.S. Provisional Patent Application No. 60/979,371 filed Mar. 9, 2005, the disclosure of which is herein incorporated by reference in its entirety.

### TECHNICAL FIELD

The present invention relates to flame retardants useful in styrenic polymers. More particularly, the present invention relates to phosphorous-containing tetrabromobisphenol-A flame retardants, methods for forming the same, and their use as flame retardants in styrenic polymers.

### BACKGROUND

Styrenic polymers possessing flame retardant properties are highly sought after for commercial applications. There has been much effort devoted to the discovery and development of effective flame retardants for use in styrenic polymers, especially polystyrene. One such flame retardant that has received extensive attention is tetrabromobisphenol A. This has led to tetrabromobisphenol-A being one of the most widely used brominated flame retardants in the world, and it is, thus, used extensively to provide flame retardancy to styrenic polymers, thermoplastics, and to some thermoset resins.

However, not all flame retardants are suitable for use in styrenic polymers because the use of the flame retardant may diminish other desired properties of the finished product. For example, in many cases effective flame retardancy can be achieved, but only at the expense of the thermal stability of the final polystyrenic product.

Thus, there exists a need in the art for an effective flame retardant for use in styrenic polymers that does not diminish the thermal stability of the polystyrenic product.

### SUMMARY OF THE INVENTION

In one embodiment, the present invention relates to a flame retardant composition having the formula:

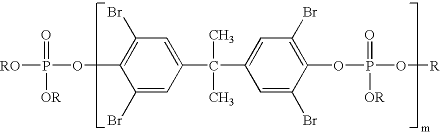

wherein each R is independently selected from alkyl groups and phenyl groups, m is an integer equal to or greater than 1, and said alkyl groups have from about 1 to about 6 carbon atoms.

In another embodiment, the present invention relates to a flame retarded polymer composition comprising:
a) a major portion of a styrenic polymer; and
b) a minor portion of a flame retardant composition having the formula: 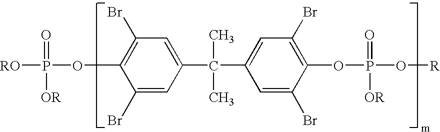
wherein each R is independently selected from alkyl groups and phenyl groups, m is an integer equal to or greater than 1, and said alkyl groups have from about 1 to about 6 carbon atoms.

In another embodiment, the present invention relates to a method for making a flame retardant composition comprising:
a) reacting tetrabromobisphenol-A with a molar excess of tertiary amine in the presence of a solvent effective at solubilizing at least a portion of the tetrabromobisphenol-A and tertiary amine under first effective reaction conditions, thereby forming an intermediate reaction product comprising a tetrabromobisphenol-A aminic salt, wherein the solvent is non-reactive under the first effective reaction conditions and the molar excess of tertiary amine is a molar ratio of at least 2 moles of tertiary amine per mole of tetrabromobisphenol-A; and
b) reacting the intermediate reaction product with a chloro-phosphate compound under second effective reaction conditions thereby forming a reaction product comprising a flame retardant composition having the formula: 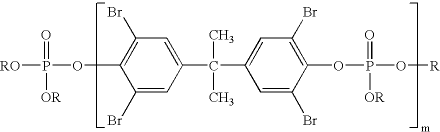
wherein each R is independently selected from alkyl groups and phenyl groups, m is an integer equal to or greater than 1, and said alkyl groups have from about 1 to about 6 carbon atoms.

### DETAILED DESCRIPTION OF INVENTION:

In one embodiment, the present invention is a flame retardant composition having the formula:

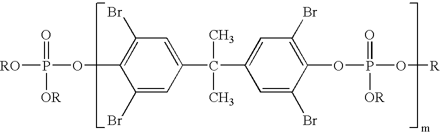

In this composition, m is an integer equal to or greater than about 1, preferably greater than about 1 to less than about 25, more preferably greater than about 1 to less than about 15, most preferably greater than about 1 to less than about 10. Each R is independently selected from alkyl groups having from about 1 to about 6 carbon atoms and phenyl groups. These groups can be substituted by halo, alkyl, aryl, or haloalky or haloaryl groups. In preferred embodiments R is an alkyl group having about 1 to about 3 carbon atoms, most preferably 2 carbon atoms.

Flame retardant compositions according to the present invention can be suitably formed by reacting tetrabromobisphenol-A with a molar excess of tertiary amine. The reaction is conducted in the presence of a solvent and under first effective reaction conditions, thereby forming an intermediate reaction product comprising a tetrabromobisphenol-A aminic salt. This reaction is preferably conducted by adding the molar excess of tertiary amine to a slurry comprising the tetrabromobisphenol-A and solvent under first effective reaction conditions.

The inventors hereof have discovered that it is critical in the present invention to use a tertiary amine in forming the intermediate reaction product. Tertiary amines suitable for use herein are any of those known. It is preferred, however, to use a tertiary alkyl amine selected from triethlyamine, trimethylamine, dimethylbutylamine, cyclic amines such as pyridine, aromatic amines such as N,N-dimethlyl aniline, and mixtures thereof. In a more preferred embodiment, the tertiary amine is triethylamine.

By a molar excess of tertiary amine, it is meant that the initial molar ratio of tertiary amine to tetrabromobisphenol A is at least about 2:1. In preferred embodiments, a molar excess of tertiary amine is to be considered a molar ratio of tertiary amine to tetrabromobisphenol A in the range of from about 2:1 to about 6:1, more preferably from about 3:1 to about 5:1.

“First effective reaction conditions” as used herein are to be considered those conditions effective at producing the intermediate reaction product comprising a tetrabromobisphenol-A aminic salt. These conditions generally include temperatures ranging from about 0° C. to about 120° C., preferably from about 25° C. to about 80° C. It is more preferred that first effective reaction conditions include stirring or agitation. Ambient pressures are preferred, but super-atmospheric pressures can be employed also.

Solvents, sometimes referred to herein as reaction solvents, suitable for use herein are those effective at solubilizing at least a portion, preferably substantially all, of the tetrabromobisphenol A and tertiary amine and are non-reactive under the first effective reaction conditions. These solvents include toluene, benzene, xylene, chlorobenzene, bromobenzene, methylene chloride, chloroform, dioxane, dibromomethane, and mixtures thereof. In preferred embodiments, the solvent is selected from toluene, xylene, and mixtures thereof, more preferably toluene.

The intermediate reaction product formed comprises a tetrabromobisphenol-A aminic salt, and typically the solvent also. Thus, the intermediate reaction product is typically a slurry comprising the tetrabromobisphenol-A aminic salt and the solvent. For example, if the tertiary amine is triethylamine and the solvent is toluene, then the intermediate reaction product will be a slurry comprising tetrabromobisphenol-A-triethylaminic salt and toluene.

To form a flame retardant composition having the above-described formula, the intermediate reaction product is reacted under second effective reaction conditions with a chloro-phosphate compound. This reaction is preferably carried out by adding, preferably gradually, the chloro-phosphate compound to the intermediate reaction product, thereby forming the reaction product comprising a flame retardant composition of the present invention.

Second effective reaction conditions are any conditions under which the reaction product and chloro-phosphate form the flame retardant composition of the present invention. These conditions generally include temperatures of from about 0° C. to about 120° C., preferably from about 25° C. to about 110° C. Stirring or agitation is also preferred. Ambient pressures are preferred, but super-atmospheric pressures can be employed also. It should be noted that the intermediate reaction product can be heated to about 40° C. to about 70° C. prior to reacting with the chloro-phosphate compound, and the reaction between the intermediate reaction product and chloro-phosphate compound is exothermic so precautionary measures such as cooling means may be necessary in order to maintain the desired reaction temperature.

Chloro-phosphate compounds suitable for use herein include any chloro-phosphate having the general formula:

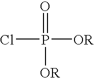

wherein R is the same as defined above in relation to the flame retardant composition of the present invention. In preferred embodiments, R is an ethyl group; thus, the chloro-phosphate compound used in preferred embodiments is diethylchlorophosphate.

The reaction of the intermediate reaction product and chloro-phosphate compound produces a reaction product comprising a flame retardant composition according to the present invention. The reaction product is typically a two-phase reaction product comprising a liquid phase and a solid phase, wherein both phases can contain a portion of the flame retardant composition of the present invention. The liquid phase comprises the reaction solvent and typically contains the majority of the flame retardant composition. The solid phase comprises reaction by-products insoluble in the reaction solvent such as, for example, hydrochloride salts of the tertiary amine.

To effect substantially full recovery of the flame retardant composition, one embodiment of the invention further comprises adding to the reaction product, under ambient conditions and stirring or agitation, an amount of water effective at dissolving the solid phase, thereby forming a water-containing system. Typically, an effective amount of water ranges from about 50 grams of water per mole of the hydrochloride salt of the tertiary amine to about 200 grams per mole of the hydrochloride salt of the tertiary amine by-product. After substantially all of the solid phase has dissolved, the stirring or agitation is discontinued, and the solution is allowed or caused to separate into an organic phase and an aqueous phase. The aqueous phase contains hydrochloride salts of the tertiary amine, which are reaction by-products insoluble in the reaction solvent.

The organic phase comprises substantially all of the flame retardant composition dissolved in the solvent, and if the solvent is toluene or xylene, the organic phase is typically and preferably lighter than the aqueous phase. Thus, if the solvent is xylene and/or toluene, then the organic phase will be the top-most phase of the two-phases. If the solvent is chloroform, methylene chloride, or the like, i.e. solvents that are heavier than water, the organic phase will be the bottom-most phase of the two-phases. The organic phase is recovered, optionally washed with water to remove any entrained reaction by-products, and concentrated by removing at least a portion of the solvent and any minor amount of water that may be present in the organic phase thereby forming a concentrated organic phase. Preferably substantially all the solvent and minor amount of water present is removed. Once at least a portion of the solvent and any minor amount of water has been removed, the concentrated organic phase is preferably essentially a flame retardant composition according to the present invention.

The means by which the organic phase is recovered is not critical to the instant invention and can be selected from any techniques effective at separating two liquid phases having different densities. Likewise, the means by which the organic phase is concentrated is not critical to the instant invention and can be selected from any known concentration techniques such as decantation, centrifugation, evaporation, rotary evaporation, and the like. Evaporation is the preferred concentration method. It should be noted that it is within the scope of the present invention to utilize an external heat source to speed the evaporation.

The concentrated organic phase is allowed to cool to ambient temperature, or optionally, external cooling means may be used to facilitate the cooling. The external cooling means used is not critical to the instant invention. Non-limiting examples of suitable external cooling means include ice or water baths or heat exchangers. The cooling of the concentrated organic phase causes the flame retardant particles in the concentrated organic phase to precipitate out of the concentrated organic phase. The solidified flame retardant particles can then be washed with water to remove any impurities and allowed to dry. It should be noted that if the organic phase is not concentrated, the cooling of the concentrated organic phase causes solubilized flame retardant particles in the organic phase to precipitate out of solution. The precipitated flame retardant particles can then be recovered and washed with water to remove any impurities and allowed to dry.

The above-described flame retardant composition is useful in imparting flame retardancy to styrenic polymers. Thus, in one embodiment, the present invention relates to a flame retarded polymer composition comprising a major portion of a styrenic polymer and a minor portion of a flame retardant composition according to this invention. By a major portion of styrenic polymer, it is meant greater than about 50 wt %, based on the weight of the based on the weight of the flame retarded polymer composition. Preferably a major portion is to be considered greater than about 75 wt. %, on the same basis, and more preferably from about 75 wt. % to about 85 wt. % on the same basis. By a minor portion of a flame retardant composition of the present invention, it is meant less than about 50 wt %, based on the weight of the flame retarded polymer composition, preferably less than about 25 wt. %, on the same basis, and more preferably from about 15 wt. % to about 25 wt. % on the same basis.

Non-limiting examples of styrenic polymers suitable for use herein include high impact polystyrene (“HIPS”), ABS, polycarbonate ABS, expanded polystyrene, and beaded polystyrene. It is preferred that the styrenic polymer be a polymer selected from expanded polystytrene and beaded polystyrene, more preferably expanded polystyrene.

Optionally, the flame retarded polymer composition may also comprise compounds commonly used in formulating flame retarded styrenic polymer compositions. These formulation compounds are typically and preferably selected from plasticizers, impact modifiers, antioxidants, UV stabilizers, pigments and fillers. The amounts of the optional formulation compounds is not critical to the present invention and can be any amount commonly used in the art and can be varied to suit the needs of any given situation

The flame retardant composition of this invention and a styrenic polymer can be formulated into a flame retarded polymer composition by any formulation techniques known. For example, the flame retardant composition of this invention may be incorporated into the styrenic polymer by wet or dry techniques. Non-limiting examples of dry techniques include those wherein the flame retardant composition of this invention is mixed with pellets of the styrenic polymer, and this mixture is then extruded under elevated temperatures sufficient to cause the styrenic polymer to melt. Non-limiting examples of wet methods include mixing a solution of the flame-retardant composition of this invention with molten polystyrenic resin.

The above description is directed to several means for carrying out the present invention. Those skilled in the art will recognize that other means, which are equally effective, could be devised for carrying out the spirit of this invention. The following examples will illustrate the present invention, but are not meant to be limiting in any manner.

### EXAMPLES

### Examples 1

In this Example, a flame retardant compound according to the present invention was formed. The flame retardant composition was tetrabromobisphenol A bis-(diethylphosphate).

To form the tetrabromobisphenol A bis-(diethylphosphate), a 1-liter four-necked vessel was used as the reactor, and it was equipped with a mechanical stirrer, a glycol-cooled (0° C.) reflux condenser, a thermometer equipped with a temperature regulator, and addition funnel, and a nitrogen flush assembly. Nitrogen was charged to the reactor to provide a nitrogen-rich atmosphere, and 54.4 g (0.1 mol) tetrabromobisphenol A (“TBBPA”) was added to the reactor. After all of the TBBPA was added, 300 ml of dry toluene was added under constant stirring at a temperature of 25° C. To the stirring mixture, 40.5 g (0.4 mol, a 100% stoichiometric excess) of triethylamine (“TEA”) was added dropwise over a 10 minute period. The addition of the TEA formed a white precipitate containing TBBPA-triethylaminic salt. After the formation of the salt, the contents of the reactor were heated to 60° C. It should be noted that the toluene and TEA were added to the reactor under constant stirring.

After the contents were heated to 60° C., 34.5 g (0.2 mol) of Aldrich diethylchlorophosphate (“DECP”) was added to the reactor under constant stirring over a 10 minute period. The temperature of the reactor rose to about 85° C. during this period. The contents of the reactor were stirred for an additional 30 minutes after all of the DECP had been added, during which time the reaction temperature dropped to about 70° C., and the white TBBPA-triethylaminic precipitated salt dissolved, thus forming a clear solution.

A small, about 1 to about 2 ml, sample of the clear solution was withdrawn from the reaction vessel and analyzed via P-31 spectral analysis. The P-31 analysis was performed on a Bruker 400 MHz spectrometer Model Avance DPX 400. The sample to be analyzed was prepared by mixing the small sample of the solution with about 1 to about 3 ml deuterated chloroform (“CDCl₃”) and then placing the prepared sample in the spectrometer. Analysis of the P-31 spectrum showed a single, sharp absorption peak at—6.466 ppm indicating the formation of the desired tetrabromobisphenol A bis-(diethylphosphate) product and essential completion of the reaction.

The clear solution was allowed to cool in the reactor to about 30° C. About 300 ml of water was added to the cooled reactor contents under constant stirring. The addition of the water dissolved substantially all of any TEA hydrochloride salt by-product formed during the reaction. After the water had been added, the mechanical stirrer was turned off, and a two-phase liquid system was observed to form.

The upper layer of the 2-phase system was the organic layer, and it was withdrawn from the reaction vessel, washed with 300 ml of water, and then concentrated on a rotary evaporator. The concentration of the washed organic layer yielded a thick oily liquid, which was allowed to stand overnight during which time the concentrated, washed organic layer solidified. The solid was collected and placed on a sintered glass funnel filter having a coarse porosity, where it was washed with water 3 times using 150 ml of water each time. The washing of the solid yielded a white solid that was allowed to dry overnight under ambient temperature and pressure.

The dried solid was collected and weighed. The dried solid weighed about 78.5 grams (0.096 mol) indicating a 96.2% yield, based on the TBBPA. The melting point of the material was determined by capillary on MEL-TEMP instrument, manufactured by Laboratory Devices, and the dried solid was found to have a melting point in the range of from about 98 to about 100° C. An H-1 and P-31 spectrum analysis was performed using the same machine and under the same procedures outlined above in relation to the P-31 analysis of the clear solution. The P-31 spectrum indicated a single absorption peak at—5.66 ppm, and the H-1 spectrum showed absorptions at 1.45 ppm, (indicating m, 12H, methyl group), 1.60 ppm (indicating s, 6H, isopropyldiene group), 4.35 ppm (indicating m, 8H, methylene groups), and 7.35 ppm (indicating indicating s, 4H, aromatic groups). The P-31 and H-1 spectrums indicated the formation of the desired tetrabromobisphenol A bis-(diethylphosphate) product.

### Example 2

In this Example, another flame retardant compound according to the present invention was formed. This flame retardant compound was tetrabromobisphenol A bis-(dimethylphosphate).

The same reactor as used in Example 1 was used herein. To the reactor was added 108.8 g (0.2 mol) TBBPA, and after all of the TBBPA was added, 600 ml of dry toluene was added. The toluene was added to the reactor under conditions that included a nitrogen-rich atmosphere, constant stirring and a temperature of 25° C. To the stirring mixture 80.6 g (0.8 mol, a 100% stoichiometric excess) TEA was added drop-wise over a 10 minute period. The addition of the TEA formed a creamy-white precipitate of TBBPA-triethylaminic salt.

57.8 g (0.4 mol) of Aldrich dimethylchloro phosphate (“DMCP”) was then added to the reactor under constant stirring over a 10 minute period. The temperature of the reactor varied from about 25° C. to about 35° C. during this period. It should be noted that since DMCP is highly unstable, bubbling and gas generation due to decomposition of the material was observed, leading to a slight excess of TBBPA in the reactor.

After the DMCP was added, the contents of the reactor were stirred overnight at room temperature. After overnight stirring, a toluene layer formed in the reactor, and it was extracted therefrom. To the reactor was then added an additional 300 ml of toluene in an effort to extract substantially all of the tetrabromobisphenol A bis-(dimethylphosphate) .product from the contents of the reactor, i.e. collect all of the tetrabromobisphenol A bis-(dimethylphosphate) product while not recovering the TEA hydrochloride salt formed as a by-product of the formation reaction. The toluene layer was again extracted from the reactor, and it was combined with the other toluene layer extracted therefrom.

The combined toluene layers were concentrated on a rotary evaporator at 80° C. to produce a thick oily liquid, which was allowed to stand for 3.5 hours during which time the concentrated toluene layers solidified. The solid was collected and placed on a sintered glass funnel filter having a coarse porosity, where it was washed with water 3 times using 150 ml of water each time. The washing of the solid yielded a white solid that was allowed to dry overnight under ambient temperature and pressure.

The dried solid was collected and weighed. The dried solid weighed about 28 grams (0.037 mol) indicating an 18.4% yield, based on the TBBPA. While not wishing to be bound by theory the inventors hereof attribute the reduced yield of tetrabromobisphenol A bis-(dimethylphosphate) product to the decomposition of the DMCP. The melting point of the material was determined according to the capillary method described in Example 1 above, and the dried solid was determined to have a melting point in the range of from about 150 to about 156° C. An H-1 and P-31 spectrum analysis was performed using the same machine and under the same procedures outlined in Example 1 above. The P-31 spectrum indicated a single absorption peak at −4.3 ppm, and the H-1 spectrum showed absorptions at 1.6 ppm, (indicating s, 6H, isopropylidiene group), 4.0 ppm (indicating d, 12H, methyl groups), 7.35 ppm (indicating s, 4H, aromatic groups). The P-31 and H-1 spectrums indicated the formation of the desired ietrabromobisphenol A bis-(dimethylphosphate) product.

### Example 3

In this Example, yet another flame retardant compound according to the present invention was formed. This flame retardant compound was tetrabromobisphenol A bis-(diphenylphosphate).

The same reactor as used in Examples 1 and 2 was used herein. To the reactor was added 54.4 g (0.1 mol) TBBPA, and after all of the TBBPA was added, 350 ml of dry toluene was added. The toluene was added to the reactor under conditions that included a nitrogen-rich atmosphere and constant stirring. To the stirring mixture 40.5 g (0.4 mol, a 100% stoichiometric excess) TEA was added all at once. The reactor contents were stirred for thirty minutes after the TEA addition at room temperature (23-25° C.) during which time a white precipitate of TBBPA-triethylaminic salt. The contents of the reactor were heated to about 60° C., and it was observed that an exotherm raised the temperature to 70° C. at one point during the heating.

53.7 g (0.2 mol) of Aldrich diphenylchlorophosphate (“DPCP”) was then added to the reactor under constant stirring over a 25 minute period. The temperature of the reactor was maintained at 70° C. during the DECP addition. After all of the DPCP was added to the reactor, the reactor contents were heated to about 84° C. to about 85° C. under constant stirring, and the rector contents were subjected to these conditions for about an hour during which a yellowish-clear solution formed. The reaction mixture was allowed to cool to ambient temperature, and 400 ml of water and 100 ml of additional toluene was then added to the reactor, and the contents of the reactor were stirred for a few minutes. After stirring for a few minutes, the mechanical stirring was stopped, and the reactor contents separated into phases. The top most phase, the organic layer, was concentrated on a rotary evaporator at 80° C. to remove toluene. This yielded a yellow, oily liquid, weighing 112.6 grams.

A 0.2 ml sample of this yellowish-clear liquid was withdrawn from the reaction vessel, dissolved in 1-2 mL of deuterated chloroform, and analyzed via P-31 spectral analysis. The P-31 analysis was performed as described above in Examples 1 an 2, and it indicated a single, sharp absorption peak at −17.7 ppm indicating the formation of the desired product and essential completion of the formation reaction of the same, i.e. there was no DPCP detected.

The concentrated organic layer was allowed to stand overnight during which time the concentrated, washed organic layer solidified. The solid was collected and placed on a sintered glass funnel filter having a coarse porosity, where it was washed with water 3 times using 150 ml of water each time. The washing of the solid yielded a white solid that was allowed to dry overnight under ambient temperature and pressure.

The dried solid was collected and weighed. The dried solid weighed about 109 g grams (0.108 mol) indicating a 108% yield, based on the TBBPA. The higher than theoretical yield indicates that the solvent (toluene) was not effectively removed and was trapped in the crystals of the solids. This was also confirmed by the H-1 NMR spectrum, which showed significant amount of toluene still present in the sample. No further purification was performed, however.

An H-1 and P-31 spectrum analysis was performed using the same machine and under the same procedures outlined above in relation to the P-31 analysis of the clear solution. The P-31 spectrum indicated a single absorption peak at −(17.75) ppm, and the H-1 spectrum showed absorptions at (1.55 ppm, a singlet for the methyl groups and a multiplet centered between 7.1-7.35 ppm, showing the aromatic protons). A sharp, singlet at 2.35 ppm indicated the presence of toluene still remaining in then crystals. The P-31 and H-1 spectrums indicated the formation of the desired tetrabromobisphenol A bis-(diphenylphosphate) product.

What is claimed:

1) A flame retardant composition having the formula: 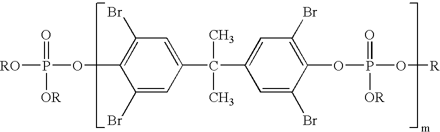
wherein each R is independently selected from alkyl groups and phenyl groups, m is an integer equal to or greater than 1, and said alkyl groups have from about 1 to about 6 carbon atoms.

2) The flame retardant composition according to claim 1 wherein said alkyl groups, and phenyl groups are substituted by at least one halo, alkyl, aryl, haloalky, or haloaryl groups.

3) The flame retardant composition according to claim 1 wherein R is an alkyl group having about 1 to about 3 carbon atoms.

4) The flame retardant composition according to claim 1 wherein R is an alkyl group having about 2 carbon atoms.

5) The flame retardant composition according to claim 1 wherein m is greater than 1.

6) The flame retardant composition according to claim 1 wherein m is an integer ranging from greater than about 1 to less than about 25.

7) The flame retardant composition according to claim 1 wherein m is an integer ranging from greater than about 1 to less than about 15.

8) The flame retardant composition according to claim 1 wherein m is an integer ranging from greater than about 1 to less than about 10

9) A method for making a flame retardant composition comprising:
a) reacting tetrabromobisphenol-A with a molar excess of tertiary amine and a solvent effective at solubilizing at least a portion of the tetrabromobisphenol-A and tertiary amine under first effective reaction conditions, thereby forming an intermediate reaction product comprising a tetrabromobisphenol-A aminic salt, wherein the solvent is non-reactive under the first effective reaction conditions and the molar excess of tertiary amine is a molar ratio of at least 2 moles of tertiary amine per mole of tetrabromobisphenol-A; and
b) reacting the intermediate reaction product with a chloro-phosphate compound under second effective reaction conditions thereby forming a reaction product comprising a flame retardant composition having the formula: 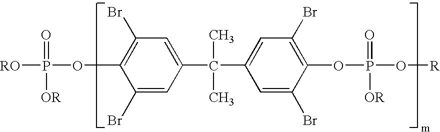
wherein each R is independently selected from alkyl groups and phenyl groups, m is an integer equal to or greater than 1, and said alkyl groups have from about 1 to about 6 carbon atoms.

10) The method according to claim 9 wherein said first effective reaction conditions include temperatures ranging from about 0° C. to about 120° C., ambient pressure, and agitation or stirring.

11) The method according to claim 9 wherein said first effective reaction conditions include temperatures ranging from about 25° C. to about 80° C.

12) The method according to claim 9 wherein said tertiary amine is selected from triethlyamine, trimethylamine, dimethylbutylamine, cyclic amines, and aromatic amines, and mixtures thereof.

13) The method according to claim 11 wherein said tertiary amine is triethylamine.

14) The method according to claim 9 wherein said molar excess of tertiary amine is a molar ratio ranging from about 2:1 to about 6:1 moles of tertiary amine per mole of tetrabromobisphenol A.

15) The method according to claim 13 wherein said molar excess of tertiary amine is a molar ratio ranging from about 3:1 to about 5:1 moles of tertiary amine per mole of tetrabromobisphenol A.

16) The method according to claim 9 wherein said solvent is selected from toluene, benzene, xylene, chlorobenzene, bromobenzene, methylene chloride chloroform, dioxane, dibromomethane, and mixtures thereof.

17) The method according to claim 9 wherein said solvent is selected from toluene, xylene, and mixtures thereof.

18) The method according to claim 15 wherein said solvent is toluene.

19) The method according to claim 9 wherein said reacting of said intermediate reaction product and said chloro-phosphate is achieved by gradually adding said chloro-phosphate to said reaction product.

20) The method according to claim 9 wherein said second effective reaction conditions include temperatures ranging from about 0° C. to about 120° C., ambient pressure, and agitation or stirring.

21) The method according to claim 18 wherein said second effective reaction conditions include temperatures ranging from about 25° C. to about 110° C.

22) The method according to claim 9 wherein said intermediate reaction product is heated to a temperature ranging from about 40° C. to about 70° C. prior to reacting with the chloro-phosphate compound.

23) The method according to claim 9 wherein said chloro-phosphate compounds is selected from those chloro-phosphate compounds having the formula: 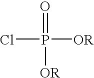
wherein R is selected from alkyl groups having from about 1 to about 6 carbon atoms, phenyl groups, and mixtures thereof.

24) The method according to claim 23 wherein R is an ethyl group.

25) The method according to claim 21 wherein said chloro-phosphate compound is diethylchlorophosphate.

26) The method according to claim 9 wherein said reaction product is a two-phase product comprising a liquid phase and a solid phase wherein both phases comprise a portion of the flame retardant composition

27) The method according to claim 26 wherein said liquid phase and said solid phase comprise at least a portion of the flame retardant composition, and wherein said solid phase further comprises reaction by-products insoluble in the solvent and the liquid phase further comprises said solvent.

28) The method according to claim 27 wherein said reaction by-products include a hydrochloride salt of said tertiary amine.

29) The method according to claim 27 wherein said method further comprises adding to the reaction product, under ambient conditions and agitation or stirring, an amount of water effective at dissolving the solid phase thereby forming a water-containing solution.

30) The method according to claim 29 wherein said amount of water effective at dissolving the solid phase ranges from about 50 grams of water per mole of said hydrochloride salt of said tertiary amine to about 200 grams of water per mole of said hydrochloride salt of said tertiary amine.

31) The method according to claim 30 wherein after substantially all of said solid phase has dissolved in said water, said agitation or stirring is discontinued, and the water-containing solution is allowed or caused to separate into an organic phase and an aqueous phase, said organic phase comprising substantially all of said flame retardant composition dissolved in said solvent and said aqueous phase comprising reaction by-product insoluble in the solvent and water.

32) The method according to claim 31 wherein said organic phase is recovered, optionally washed with water to remove any entrained undesirable by-products, and concentrated by removing at least a portion of the solvent and any minor amounts of water that may be present therein thereby forming a concentrated organic phase.

33) The method according to claim 33 wherein said organic phase is concentrated by a means selected from decantation, centrifugation, evaporation, rotary evaporation, the like, and mixtures thereof.

34) The method according to claim 33 wherein said concentrated organic phase is allowed to cool or caused to cool to room temperature thereby forming solid flame retardant particles according to the present invention.

35) The method according to claim 23 wherein said alkyl groups having from about 1 to about 6 carbon atoms and said phenyl groups are optionally substituted by at least one halo, alkyl, aryl, haloalky, or haloaryl group.

36) A flame retarded polymer composition comprising:
a) a major portion of a styrenic polymer; and
b) a minor portion of a flame retardant composition having the formula: 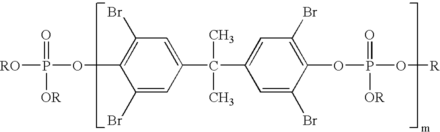
wherein each R is independently selected from alkyl groups and phenyl groups, m is an integer equal to or greater than 1, and said alkyl groups have from about 1 to about 6 carbon atoms.

37) The flame retarded polymer composition according to claim 36 wherein said major portion of styrenic polymer is greater than about 50 wt %, based on the weight of the flame retarded polymer composition.

38) The flame retarded polymer composition according to claim 36 wherein said major portion of styrenic polymer is about 75 wt. % to about 85 wt. %, based on the weight of the flame retarded polymer composition.

39) The flame retarded polymer composition according to claim 37 wherein said minor portion of said flame retardant composition is less than about 50 wt %, based on the weight of the flame retarded polymer composition.

40) The flame retarded polymer composition according to claim 38 wherein said minor portion of said flame retardant composition is about 15 wt. % to about 25 wt. %, based on the weight of the flame retarded polymer composition.

41) The flame retarded polymer composition according to claim 36 wherein said styrenic polymer is selected from high impact polystyrene (“HIPS”), ABS, polycarbonate ABS, expanded polystyrene, and beaded polystyrene.

42) The flame retarded polymer composition according to claim 36 wherein said styrenic polymer is a polymer selected from HIPS, expanded polystytrene and beaded polystyrene, more preferably expanded polystyrene.

43) The flame retarded polymer composition according to claim 36 wherein said flame retarded polymer further comprises at least one formulation compound selected from plasticizers, impact modifiers, antioxidants, UV stabilizers, pigments and fillers.

44) The flame retarded polymer composition according to claim 33 wherein said alkyl groups having from about 1 to about 6 carbon atoms and said phenyl groups are optionally substituted by at least one halo, alkyl, aryl, haloalky, or haloaryl group.
